(19) United States
(12) Patent Application Publication
(10) Pub. No.: US 2012/0217215 A1
(43) Pub. Date: Aug. 30, 2012

(54) Shower Caddy System

(76) Inventors: Robert A. Emery, Annandale, NJ (US); Joseph Gasparino, Peekskill, NY (US)

(21) Appl. No.: 13/035,113

(22) Filed: Feb. 25, 2011

(51) Int. Cl. A47K 17/00; B23P 11/00; F16B 2/20

(52) U.S. Cl. 211/119.009; 24/455; 24/570; 29/428

(57) ABSTRACT

A shower caddy system includes a tension pole, a number of shelves and a number of clips for attaching and reattaching the shelves to the tension pole. The clips are opened and closed when attaching and reattaching the shelves to the tension pole. Repositioning a shelf to a new location on the tension pole therefore does not require the removal of the tension pole from a shower stall or bathtub/shower area, thereby saving a user a significant amount of time and effort.

### FIELD OF THE INVENTION

The present invention relates to shower caddy systems, and, more particularly, to shower caddy systems that include a tension pole and shelves that may be attached to the pole at various locations along its length.

### BACKGROUND OF THE INVENTION

Shampoo bottles, bar and liquid soaps, shaving supplies and various other personal hygiene items are usually kept in the home bathroom shower stall or bathtub/shower area. Various shower caddies are available that have one or more shelves for holding the aforementioned items in an organized fashion.

### SUMMARY OF THE INVENTION

In one embodiment, the present invention provides a shower caddy system comprising at least one tension pole segment, at least one shelf, and means for attaching and reattaching the at least one shelf to the at least one tension pole segment at any point thereon. In one specific example, the attaching and reattaching means includes a clip having a first portion and a second portion engaging the first portion at a first end thereof. The first portion includes a second end opposite its first end, and the second portion includes a third end and a fourth end opposite the third end. In another example, the third end of the second portion engages the first end of the first portion such that the first portion is moveable with respect to the second portion from a first position in which the second end of the first portion is separate from the fourth end of the second portion, and the clip is open, to a second position in which the second end of the first portion is adjacent the fourth end of the second portion, and the clip is closed.

In another example, the first and second portions of the clip are sized and shaped so that the clip substantially encircles a cross section of the tension pole when the first portion is in its second position and the clip is closed.

In yet another example, a portion of the at least one shelf is adapted to engage the second end of the first portion of the clip and the fourth end of the second portion of the clip when the first portion is in its second position and the clip is closed.

In yet another example, the first and second portions of the clip include first and second protrusions, respectively. The projections have respective first and second shapes that are complimentary such that the first and second protrusions form a composite protrusion when the first portion is in its second position (i.e., when the clip is closed). The composite protrusion is sized and shaped to receive a shelf thereon.

In another embodiment, the clip has a one-piece construction. In yet another embodiment, the clip has a multi-piece construction.

In another embodiment, the present invention includes a method for arranging the shelves of the shower caddy, comprising the steps of securing the tension pole adjacent a shower location, attaching a first shelf on the tension pole at a first location thereon, removing the first shelf from the tension pole without moving the tension pole, and reattaching the first shelf on the tension pole at a second location thereon. In yet another example, the method further comprises the step of securing a first clip to the tension pole, wherein the steps of attaching the first shelf on the tension pole and reattaching the first shelf on the tension pole include securing the first shelf to the first clip. In yet another example, the method further comprises attaching a second shelf on the tension pole at a third location thereon, removing the second shelf from the tension pole without moving the tension pole, and reattaching the second shelf on the tension pole at a fourth location thereon.

### BRIEF DESCRIPTION OF THE DRAWINGS

For a more complete understanding of the present invention, reference is made to the following detailed description of an exemplary embodiment considered in conjunction with the accompanying drawings, in which:

FIG. 1 is an exploded perspective view of a shower caddy system according to an embodiment of the present invention;

FIG. 2 is a top perspective view of a shelf of the shower caddy system of FIG. 1;

FIG. 3 is a top perspective view of a clip of the shower caddy system of FIG. 1;

FIG. 4 is a top perspective view of the clip of FIG. 3 engaging a tension pole;

FIG. 5 is a top plan view of the clip and tension pole of FIG. 4; and

FIG. 6 is a top perspective view of a the shelf of FIG. 2 being attached to the clip and the tension pole according to one embodiment of the present invention.

### DETAILED DESCRIPTION OF THE INVENTION

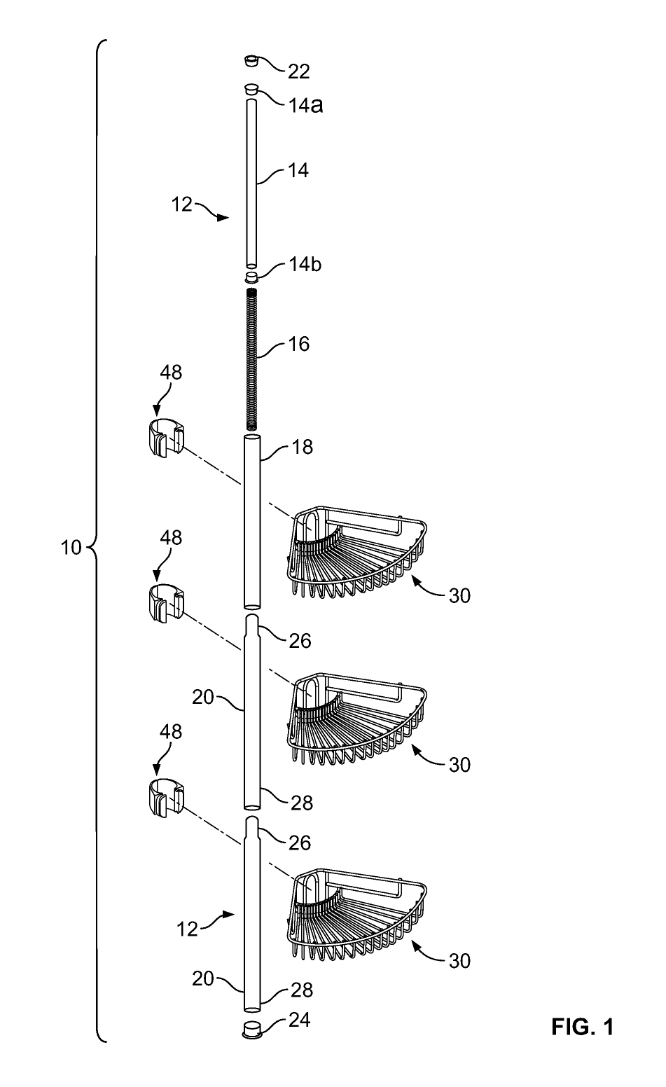

FIG. 1 illustrates a shower caddy system 10 constructed in accordance with an embodiment of the present invention. The shower caddy system 10 includes a tension pole 12 that is adapted for installation in a home bathroom shower stall or adjacent a bathtub/shower area. By way of example, FIG. 1 illustrates interconnecting components comprising the tension pole 12, including an inner tube 14 having caps 14a, 14b on both its respective ends, a tension spring 16, an outer tube 18 which receives the tension spring 16 and partially receives the inner tube 14 in a top opening thereof, pole segments 20, and end caps 22, 24. The pole segments 20 each have a tapered, closed end 26 and an open end 28 so that they may be connected to each other and/or to the outer tube 18. In assembling the tension pole 12, the spring 16, inner tube 14, outer tube 18 and pole segments 20 are connected to each other, as illustrated in FIG. 1. The end caps 22, 24 are then attached at the respective ends of the tension pole 12.

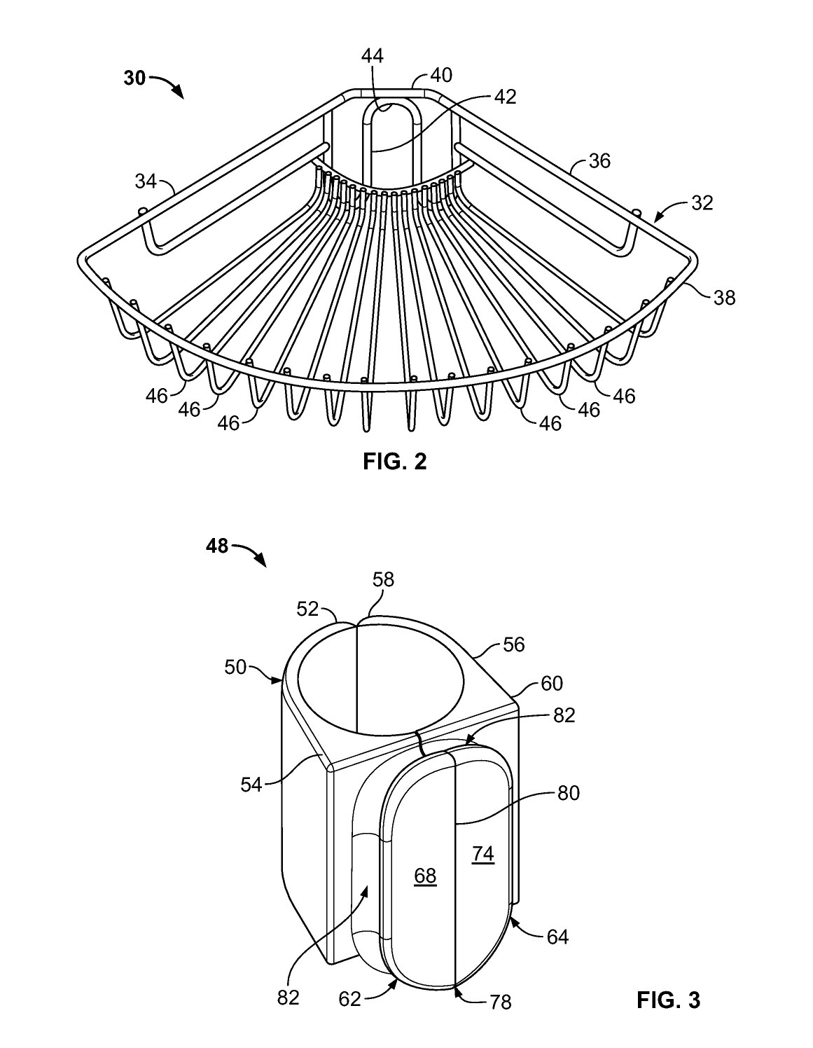

In another embodiment, the shower caddy system 10 also includes one or more self-draining shelves 30, as illustrated in FIG. 1. By way of example, FIG. 2 illustrates a shelf 30 that is shaped for placement in the corner of a shower stall or bathtub/shower area. More particularly, the shelf 30 includes a four-sided frame 32 having two side sections 34, 36, a curved front section 38 and a rear section 40. A vertical, substantially sinusoidal member 42 engages the rear section 40, and includes a central curved portion 44 having an upside-down “U” shape, the purpose of which is explained hereinbelow. A plurality of support members 46 extend between the side sections 34, 36 and from the rear section 40 to the front section 38, and are arranged so as to support shampoo bottles, soap, etc. (not shown), and to facilitate drainage from such items into the shower stall or bathtub.

In another embodiment, with reference to FIGS. 1 and 3-6, the shower caddy system 10 is provided with one or more clips 48 for attaching the shelves 30 to the tension pole 12 (i.e., one clip 48 is provided for each shelf 30 to be attached to the tension pole 12). The clips 48 also facilitate the removal and the reattachment of the shelves 30, for example, at another point on the tension pole 12, as further explained hereinbelow.

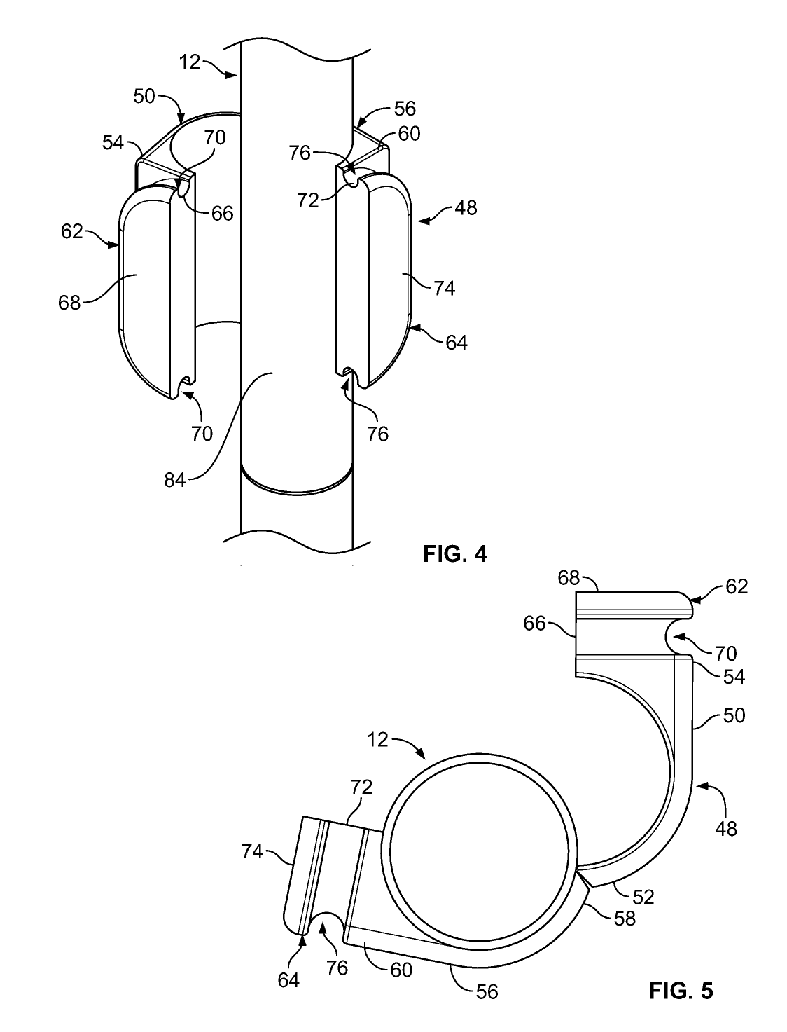

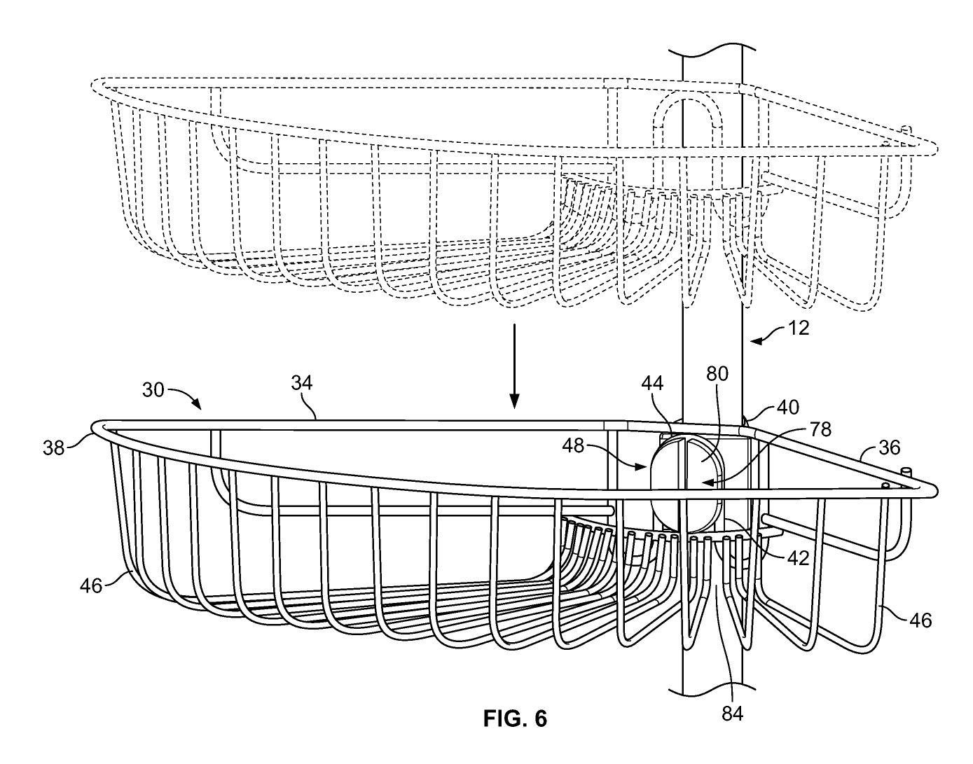

In another embodiment, each of the clips 48 has a first portion 50 that includes opposed first and second ends, 52, 54, respectively, and a second portion 56 that engages the first portion 50 and includes opposed third and fourth ends, 58, 60. More particularly, the first end 52 of the first portion 50 engages the third end 58 of the second portion 56 (see FIGS. 3 and 5). The first portion 50 is thereby moveable with respect to the second portion 56 from a first position, in which the second end 54 of the first portion 50 is separate from the fourth end 60 of the second portion 56, wherein the clip 48 is “open” (e.g., see FIGS. 4 and 5), to a second position, in which the second end 54 of the first portion 50 is adjacent the fourth end 60 of the second portion 56, wherein the clip 48 is “closed” (e.g., see FIGS. 3 and 6). In yet another example, the first and second portions 50, 56 of the clip 48 are also sized and shaped so that the clip 48 substantially encircles a cross section of the tension pole 12 when the first portion 50 is in its second position and the clip 48 is closed, as illustrated in FIG. 6.

In another embodiment, referring again to FIGS. 3-5, the second end 54 of the first portion 50 of the clip 48 includes a first protrusion 62, and the fourth end 60 of the second portion 56 of the clip 48 includes a second protrusion 64. The first protrusion 62 includes a first neck 66, or stem, and a first flange 68 attached to the first neck 66 and having a greater length and width than the first neck 66, so as to define a first channel 70 adjacent the first neck 66 and first flange 68 (see FIGS. 3 and 5). In yet another example, as also illustrated in FIG. 5, the second protrusion 64 includes a second neck 72, or stem, and a second flange 74 attached to the second neck 72 and having a greater length and width than the second neck 72, so as to define a second channel 76 adjacent the second neck 72 and the second flange 74. The first protrusion 62 therefore has a first shape, and the second protrusion 64 has a second shape which is complimentary to the first shape. More particularly, in another embodiment, when the first portion 50 of the clip 48 is in its second position, wherein the second end 54 of the first portion 50 is adjacent the fourth end 60 of the second portion 56, the first and second protrusions 62, 64 form a composite protrusion 78 having a composite neck (not shown), a composite flange 80 and a composite channel 82 (see FIG. 3). The composite neck, composite flange 80 and composite channel 82 are sized and shaped so as to receive the central curved portion 44 of the sinusoidal member 42 of the shelf 30, as further discussed hereinbelow.

In one embodiment, the clip 48 has a one-piece construction. For example, the first and second portions 50, 56 may be integrally formed from one piece of material. In another embodiment, the clip 48 has a multi-piece construction.

For example, the first portion 50 may be formed from a first piece of material, and the second portion 56 may be formed from a second piece of material and fastened to the first portion 50, e.g., at the junction of the first end 52 of the first portion 50 and the third end 58 of the second portion 56.

In use, the shower caddy system 10 may be installed according to the following steps. Once assembled, as described above, the tension pole 12 may be secured in a shower stall or adjacent a bathtub/shower area. More particularly, the inner tube 14 and the tension spring 16 may be compressed into the outer tube 18, temporarily decreasing the length of the tension pole 12 and thereby allowing a user to insert the tension pole 12 between the ceiling and floor of a shower stall or between the ceiling and the tub of the bathtub/shower area of a bathroom. Once the tension pole 12 is positioned, the inner tube 14 and tension spring 16 may be allowed to return to their neutral positions, whereupon the tension pole 12 is secured in place via an interference or friction fit with the ceiling and shower stall floor or bathtub. At least a small space is left between the tension pole 12 and the walls of the shower stall or bathtub/shower area, so that the shelves 30 may be attached and adjusted.

In another embodiment, a first location 84 on the tension pole 12 is selected for placement of a first shelf 30, and a first clip 48 is secured to the tension pole 12 at the first location 84, as illustrated in FIGS. 4 and 5. More particularly, the first portion 50 of the clip 48 is moved from its second position to its first position, so that the clip 48 is open. The clip 48 is then placed around the tension pole 12 at the first location 84, with the first portion 50 engaging one side of the tension pole 12 and the second portion 56 engaging the opposite side of the tension pole 12. The clip 48 is placed so that its protrusions 62, 64 are facing outwardly (i.e., facing away from the walls of the shower stall or bathtub/shower area). The first portion 50 of the clip 48 is then moved from its first position to its second position, such that the second end 54 of the first portion 50 is adjacent the fourth end 60 of the second portion 56. The first and second protrusions 62, 64 are thereby aligned to form the composite protrusion 78. In this manner, the clip 48 is secured around the tension pole 12 in its closed position, as illustrated in FIG. 6.

In another embodiment, with continuing reference to FIG. 6, the first shelf 30 is attached to the tension pole 12 at the first location 84 by connecting the first shelf 30 to the composite protrusion 78 of the first clip 48. More particularly, the first shelf 30 is fit onto the first clip 48 by inserting the central curved portion 44 of the sinusoidal member 42 of the first shelf 30 into the composite channel 82 of the composite protrusion 78. The first shelf 30 is then pushed in a downward direction to secure the central curved portion 44 within the composite channel 82 (not shown), which forces the closed first clip 48 tight against the tension pole 12, and ultimately locks the first shelf 30 in place. Once the first shelf 30 has been attached to the tension pole 12, additional shelves 30 may be secured to the tension pole 12 using additional clips 48.

Once all of the shelves 30 have been attached to the tension pole 12, the entire shower caddy system 10 may be pushed against the walls of the shower stall or bathtub/shower area to secure it in place. The aforementioned shower items may then be placed on the shelves 30.

In another embodiment, with the open and closeable clip 48 of the present invention, there is no need to remove the entire tension pole 12 to move one or more of the shelves 30. More particularly, repositioning a shelf 30 to a new location on the tension pole 12 does not require the removal of the tension pole 12 from the shower stall or bathtub/shower area, and thereby saves a user a significant amount of time and effort. To reposition a shelf 30, the shelf 30 is lifted up until it is disengaged from its associated clip 48. The first portion 50 of the clip 48 is then moved from its second position to its first position to open same, and the clip 48 is then removed from the tension pole 12 and placed at a new (i.e., second) location thereon. The clip 48 is secured to the tension pole 12 at the new location by moving the first portion 50 thereof from its first position to its second position to close same. The shelf 30 is then reattached to its associated clip 48 at the new position on the tension pole 12.

It should be noted that the present invention can have numerous modifications and variations. Further, while a number of embodiments of the present invention have been described, it is understood that these embodiments are illustrative only, and not restrictive, and that many modifications and/or alternative embodiments may become apparent to those of ordinary skill in the art. Therefore, it will be understood that the appended claims are intended to cover all such modifications and embodiments that come within the spirit and scope of the present invention.

We claim:

1. A shower caddy system comprising:
at least one tension pole segment;
at least one shelf and
means for attaching and reattaching said at least one shelf to said at least one tension pole segment at any point thereon.

2. The shower caddy system of claim 1, wherein said attaching and reattaching means comprises a clip.

3. The shower caddy system of claim 2, wherein said clip includes a first portion and a second portion engaging said first portion at a first end thereof.

4. The shower caddy system of claim 3, wherein said first portion includes a second end opposite said first end, and said second portion includes a third end and a fourth end opposite said third end, said third end of said second portion engaging said first end of said first portion such that said first portion is moveable with respect to said second portion from a first position in which said second end of said first portion is separate from said fourth end of said second portion, to a second position in which said second end of said first portion is adjacent said fourth end of said second portion.

5. The shower caddy system of claim 4, wherein said clip has a one-piece construction.

6. The shower caddy system of claim 4, wherein said clip has a multi-piece construction.

7. The shower caddy system of claim 4, wherein a portion of said at least one shelf is adapted to engage said second end of said first portion and said fourth end of said second portion when said first portion is in its said second position.

8. A method for arranging shelves of a shower caddy, said method comprising the steps of:
securing a tension pole adjacent a shower location;
attaching a first shelf on the tension pole at a first location thereon;
removing the first shelf from the tension pole without moving the tension pole; and
reattaching the first shelf on the tension pole at a second location thereon.

9. The method of claim 8, further comprising the step of securing a first clip to the tension pole, wherein the steps of attaching the first shelf on the tension pole and reattaching the first shelf on the tension pole include securing the first shelf to the first clip.

10. The method of claim 8, further comprising the steps of:
attaching a second shelf on the tension pole at a third location thereon;
removing the second shelf from the tension pole without moving the tension pole; and
reattaching the second shelf on the tension pole at a fourth location thereon.

11. A clip comprising:
a first portion having a first end and a second end; and
a second portion having a third end and a fourth end,
said first end of said first portion engaging said third end of said second portion such that said first portion is moveable with respect to said second portion from a first position in which said second end of said first portion is separate from said fourth end of said second portion, to a second position in which said second end of said first portion is adjacent said fourth end of said second portion.

12. The clip of claim 11, wherein said second end includes a first protrusion, and said fourth end includes a second protrusion.

13. The clip of claim 12, wherein said first protrusion has a first shape and said second protrusion has a second shape that is complimentary to said first shape such that said first and second protrusions form a composite protrusion when said first portion is in its said second position.

14. The clip of claim 13, wherein said composite protrusion is sized and shaped to receive a shelf thereon.

15. The clip of claim 11, wherein said clip has a one-piece construction.

16. The clip of claim 11, wherein said clip has a multi-piece construction.
